(19) United States
(12) Patent Application Publication
(10) Pub. No.: US 2009/0116250 A1
(43) Pub. Date: May 7, 2009

(54) Aerodynamic lamp socket assembly

(75) Inventors: Craig Hargreaves, Vancouver, WA (US); Darrin McDonald, Vancouver, WA (US)

Correspondence Address: ROBERT IRELAND, P.O. BOX 273, BANKS, OR, 97124, US

(73) Assignee: IP HOLDINGS LLC

(21) Appl. No.: 11/981,787

(22) Filed: Nov. 1, 2007

(51) Int. Cl. F21V 29/00

(52) U.S. Cl. 362/373

(57) ABSTRACT

A lamp socket assembly for increasing cooling efficiency by reducing cooling air turbulence in a horticulture light fixture comprising a lamp socket capable of receiving a grow lamp, and an aerodynamic structure, said lamp socket and aerodynamic structure being positioned and attached within the horticulture light fixture to facilitate the aerodynamic structure splitting the cooling stream of air around the lamp socket and grow lamp reducing cooling air resistance, turbulence, and disturbance, thus increasing cooling efficiency.

### FIELD

The present invention relates to an aerodynamic lamp socket assembly.

### TECHNICAL FIELD OF THE INVENTION

This invention relates generally to an aerodynamic lamp socket assembly wherein the invention reduces the air turbulence and air disturbance of the forced cooling air.

### BACKGROUND OF THE INVENTION

The use of artificial light to grow plants is well known in the art and many different types of grow lamps, light reflectors, and horticulture light fixtures have been proposed and utilized by the private and commercial gardener. The lamp socket assembly plays an integral role in that it provides the structure to hold the grow lamp while further providing power connection to ignite the light. Most grow lamps screw into the lamp socket assembly, similar to the attachment mechanism of a standard light bulb. Once the lamp is screwed into the lamp socket assembly, the lamp is secured and connected to electrical power.

One of many challenges in growing plants indoors centers on providing enough usable light to the plants in order to optimize plant growth and plant development. The undesirable byproduct of the required grow light is heat. The standard grow light produces tremendous amounts of unusable heat, and the heat contaminates the growing environment damaging plants, stunting growth, evaporating moisture, and creating a need to remove the heat from the growing environment which can be expensive and complicated. Besides the heat damaging the plants, excessive operating temperatures significantly degrade the operating life of the lamp, causing premature failure. It is desirable to maintain the grow lamp within it's peak operating range and evacuate the excessive heat generated by the grow lamp out of the growing environment. This dual challenge has been met by the industry with closed loop forced air cooling systems wherein the forced air cools the grow lamp and the resulting heated air is sealed from the growing environment, and evacuated out.

The forced air cooling systems works well, but the lamp sockets assembly is located in the middle of the forced cooling air stream, and causes turbulence disturbing the laminar air flow thus reducing the efficiency and effectiveness of the cooling air. The added air resistance of the grow lamp socket assembly further back pressures the entire closed loop system, requiring more force or additional cooling fan capacity to maintain adequate cooling.

In light of the afore mentioned problem with the grow lamp socket assembly and grow lamp being an obstruction to the air flow used for cooling, it would be desirable for the grow lamp socket to cause less turbulence, cause less back pressure, and allow the forced cooling air to pass over and by the grow lamp socket and grow lamp with less resistance maximizing the cooling effect.

### SUMMARY OF THE INVENTION

It is therefore an object of the present invention to provide for a lamp socket assembly for use in a horticulture light fixture that reduces the cooling air stream turbulence and resistance within said horticulture light fixture.

It is a further object of the present invention to provide for a lamp socket assembly for use in a horticulture light fixture that splits the forced cooling air stream around the lamp socket and grow lamp, thereby reducing turbulence, resistance, and back pressure.

It is a further object of the present invention to provide for a lamp socket assembly for use in a horticulture light fixture that is simple to construct, durable, and inexpensive.

It is a further object of the present invention to provide for an aerodynamic structure that is attachable to an existing lamp socket within a horticulture light fixture that is capable of splitting the forced cooling air stream around the lamp socket and grow lamp thereby decreasing air disruption, air turbulence, air resistance, and back pressure within the horticulture light fixture.

The aerodynamic structure of the present invention may be utilized with many different horticultural growing systems. Thus, it may be used in an apparatus such as shown in U.S. patent application Ser. No. 10/797,806 filed Mar. 10, 2004, inventor Dumont, the teachings of which are incorporated herein by reference for the purpose of explaining the need for forced air cooling of a horticulture light fixture.

In another pending patent application by Inventor Dumont, U.S. patent application 20070141912 filed Dec. 8, 2006, a grow lamp socket assembly is mounted within a transparent cylindrical member. Since the bulb emits a substantial amount of heat, it is preferred that the smallest surface area possible is blocked off to thereby increase the circulation throughout the transparent tube. The need for less resistance was identified to increase circulation and cooling capacity, but the known problem was addressed by minimizing the surface area of the grow lamp socket assembly, not by including an aerodynamic shape capable of splitting the forced air cooling stream around the lamp socket and grow lamp.

The aerodynamic structure of the present invention may be made of any suitable material which has the desired features of being heat resistant, non-reactive, and durable. The material could be sheet aluminum or sheet stainless, or the apparatus could be cast from another type of metal or alloy, or heat resistant plastics or polymers. The aerodynamic structure can be constructed into any shape able to split the cooling stream of air around the lamp socket.

### BRIEF DESCRIPTION OF THE DRAWINGS

Having described the invention in general terms and description, reference will be made to the accompanying figure drawings illustrating embodiments, in which:

FIG. 1 is a perspective view of one embodiment of the lamp socket assembly according to the present invention wherein the aerodynamic structure is wedge shaped;

FIG. 2 is a front side view of the embodiment in FIG. 2;

FIG. 3 is a front side view of the present invention wherein the aerodynamic structure is pyramid shaped; and

FIG. 4 is a perspective view of a horticultural light fixture incorporating the embodiment illustrated in FIG. 1 and FIG. 2.

### DETAILED DESCRIPTION OF THE INVENTION

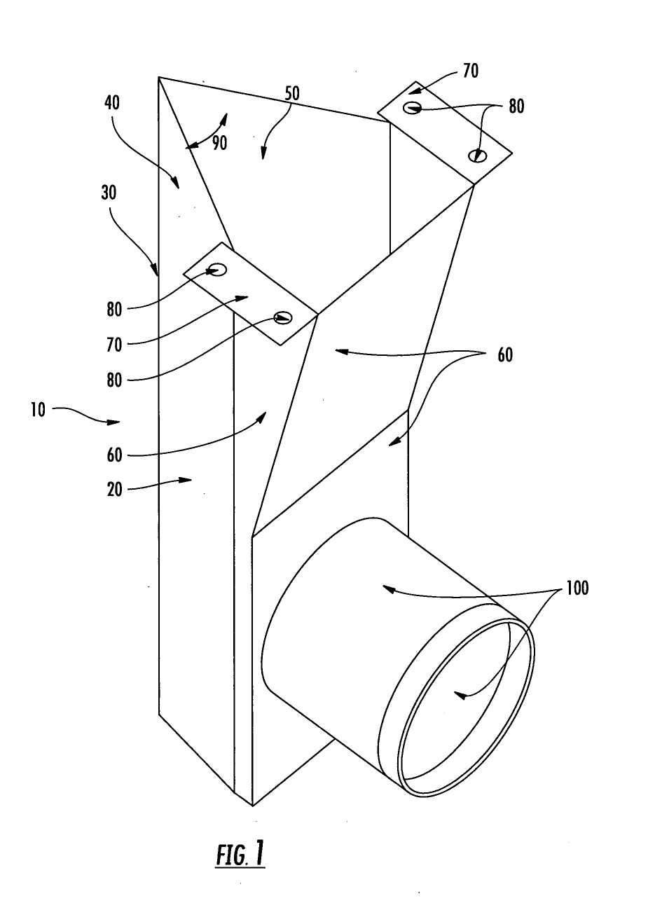

Referring to the drawings in detailed specificity and particularity, and referencing to each component via number characters, there is an illustrated embodiments in FIG. 1 wherein the lamp socket assembly 10 is configured with a wedge aerodynamic structure 20. The wedge aerodynamic structure 20 can be constructed from a single sheet of metal with a single fold line 30, having a first side 40 and a second side 50. A frame 60 provides the structure attaching the wedge aerodynamic structure 20 to the lamp socket 100. The frame 60 utilizes through holes 80 in the frame tabs 70 for a securing means. The lamp socket 100 is configured to match the desired type of grow lamp (not shown), and can receive said grow lamp via insertion or the standard method of securing by screwing into the lamp socket 100. The angle 90 between first side 40 and second side 50 must be larger than 1 degree and no more than 179 degrees, depending on desired configuration and space availability. Applicant finds through application that 75 degrees to 105 degrees of angle 90 between first side 40 and second side 50 works in most applications.

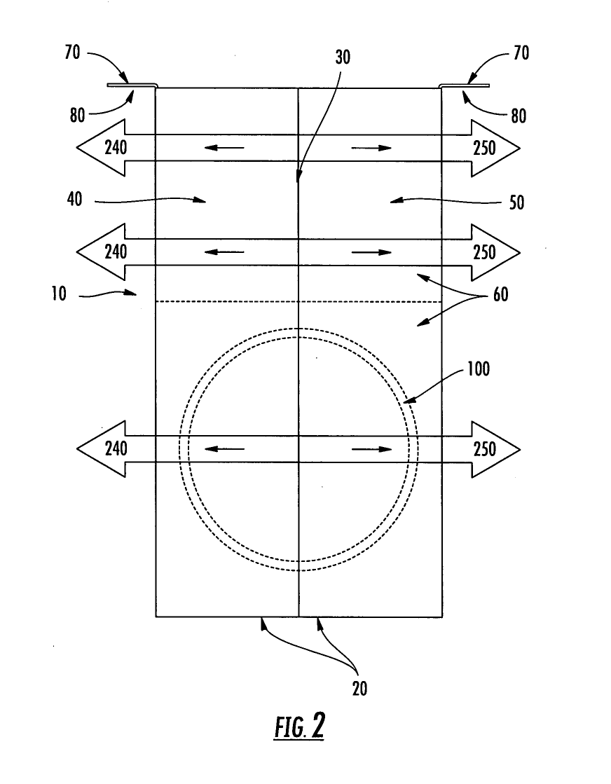

FIG. 2 further illustrating the embodiments in FIG. 1 from a front side wherein the lamp socket assembly 10 is configured with a wedge aerodynamic structure 20, the dashed lines demonstrating the relationship between the aerodynamic structure 20 completely covering the lamp socket 100 and frame 60. This relationship is important to consider as the front view shown in FIG. 2 would be the leading edge facing the cooling stream of air depicted by the first flowing 240 and second flowing 250.

The aerodynamic structure 20 splits the cooling air stream around the lamp socket 100 and frame 60 into two general direction with the first flowing 240 by the first side 40 and the second flowing 250 by the second side 50. The wedge aerodynamic structure 20 is preferably constructed from a smooth surface material to reduce drag and minimize air friction.

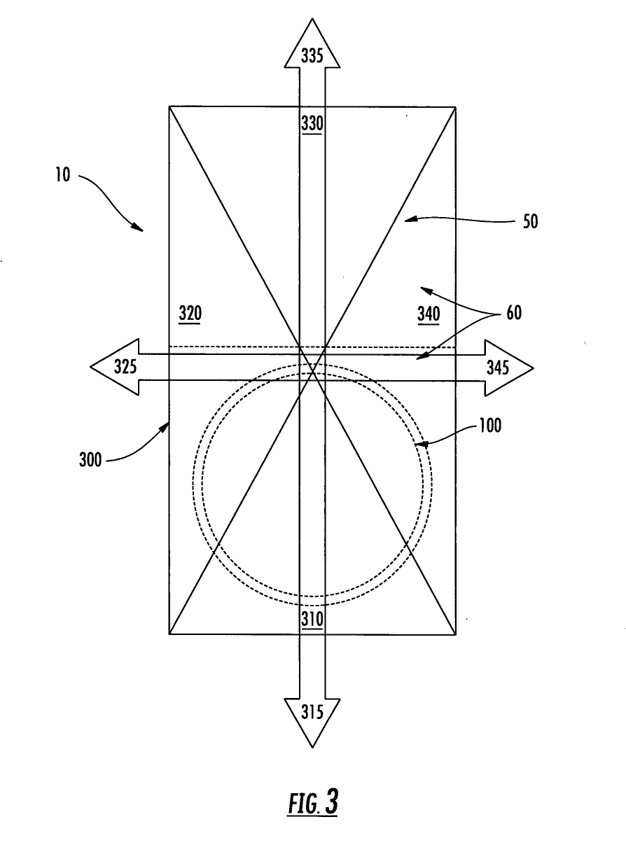

FIG. 3 illustrating a second embodiment from a front side view wherein the lamp socket assembly 10 is configured with a pyramid aerodynamic structure 300, the dashed lines demonstrating the relationship between the pyramid aerodynamic structure 300 completely covering the lamp socket 100 and frame 60. Again, this relationship is important to consider as the front view shown in FIG. 3 would be the leading edge facing the cooling stream of air.

In FIG. 3 the pyramid aerodynamic structure 300 splits the cooling air stream around the lamp socket 100 and frame 60 into four general direction with the first flowing 315 by the first side 310, the second flowing 325 by the second side 320, the third flowing 335 by the third side 330 and the fourth flowing 345 by the fourth side 340. The pyramid aerodynamic structure 300 is preferably constructed from a smooth surface material that is durable and heat resistant as the operating environment may exceed 300 degrees Fahrenheit.

The wedge aerodynamic structure 20 and pyramid aerodynamic structure 300 are only two examples of many shapes that could be utilized and would be capable of splitting the cooling stream of air.

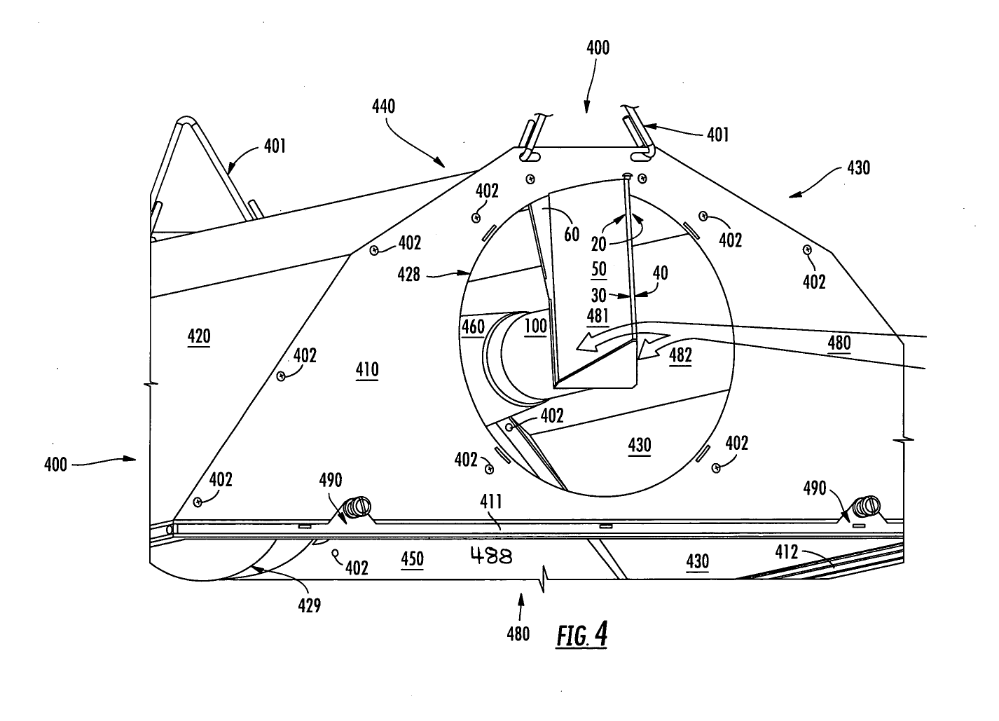

FIG. 4, Further illustrating the embodiments in FIG. 1 and FIG. 2 from a perspective view wherein the wedge aerodynamic structure 20 including the lamp socket assembly 10 is attached within a horticulture light fixture 400.

The horticulture light fixture 400 has a top portion 440, a left side portion 420, a front side portion 410, a rear side portion 450, and right side portion 430, leaving the bottom to be sealed by a clear piece of glass 488 held in place by bottom rail 411 and side rail 412. The horticulture light fixture 400 as shown is held together with a plurality of through fasteners 402. The glass 488 can be removed by loosening the fixators 490 allowing the detachment of bottom rail 411 to facilitate the removal of the glass 488. The glass 488 seals the bottom of the horticulture light fixture 400 from the growing environment, thus keeping the cooling air stream 480 that becomes heated while moving through the horticulture light fixture 400 from impacting the growing environment, while still allowing the grow light generated from the grow lamp 460 to pass through to the plants. The horticulture light fixture 400 is suspended by two hangers 401 that attach along the top side portion 440. There is a first round opening 428 and a second round opening 429 that are oppositely located on the front side portion 410 and rear side portion 450 respectively, allowing for the flow of a cooling air stream 480 to pass through the first round opening 428, over the wedge aerodynamic structure 20, the frame 60, the lamp socket 100 and the grow lamp 460, then exhausted out of the second round opening 429.

The cooling air stream 480 is created generally by a forced air system such as a fan that blows the air towards and through the first round opening 428 into the horticulture light fixture 400, and exhausted out the second round opening 429. The greater resistance encountered at the first round opening 428 the more force is required from the fan. The wedge aerodynamic structure 20 splits the cooling air stream 480 at the single fold line 30, allowing for a first flowing cooling air 481 over the second side 50 and a second flowing cooling air 482 over the first side 40. The split cooling air stream 480 smoothly flows around the socket 100, frame 60, and grow lamp 460. Without the wedge aerodynamic structure 20 the resistance encountered by the cooling air stream 480 would be greater because the cooling air stream 480 would not be split, and the disruption and turbulence of the cooling air stream 480 would be increased, thereby reducing the efficiency of the cooling air stream 480 and requiring an increase in cooling fan capacity.

One skilled in the art will understand that the above described embodiments are for purposes of illustration only and that alterations in the shape, changes in materials, and modifications in configuration may be made thereto without departing from the spirit and scope of the invention.

1. A lamp socket assembly for reducing cooling air resistance in a horticulture light fixture comprising:
a lamp socket capable of receiving a grow lamp;
an aerodynamic structure;
a horticulture grow light fixture;
a cooling stream of air;
said lamp socket and aerodynamic structure constructed and arranged within the horticulture grow light fixture having the aerodynamic structure splitting said cooling stream of air around the lamp socket.

2. The lamp socket assembly of claim 1 wherein said aerodynamic structure is constructed of a sheet material.

3. The lamp socket assembly of claim 2 wherein said aerodynamic structure is formed into a wedge shape having a single fold line.

4. The lamp socket assembly of claim 2 wherein said aerodynamic structure is formed into a pyramid shape having more than one fold line.

5. The lamp socket assembly of claim 1 wherein said aerodynamic structure is constructed by casting a heat resistant material into an aerodynamic shape.

6. A method of reducing cooling air turbulence in a horticulture light fixture, which comprises: attaching an aerodynamic structure within the cooling air stream of a horticulture light fixture so that the cooling air stream is split around the lamp socket and grow lamp.
